(19) United States
(12) Patent Application Publication
(10) Pub. No.: US 2009/0284834 A1
(43) Pub. Date: Nov. 19, 2009

(54) Floor Type Electric Projection Screen

(76) Inventor: Chang Xiu CHEN, Shenzhen (CN)

Correspondence Address: TROXELL LAW OFFICE, PLLC, P.O. Box 1370, Annandale, VA, 22003, US

(21) Appl. No.: 12/268,761

(22) Filed: Nov. 11, 2008

(30) Foreign Application Priority Data
May 16, 2008 (CN) 200820094704.X

(51) Int. Cl. G03B 21/58

(52) U.S. Cl. 359/461

(57) ABSTRACT

The present invention provides a floor type electric projection screen cooperatively used with a projector comprising a shell a projection, and a scroll. An end of the projection curtain is wound on the scroll, and the scroll is installed in the shell. A motor is defined in the projection screen. The motor drives the scroll rotating. The other end of the projection curtain is installed on a supporting bar. Supports are installed between the shell and the supporting bar. The support is formed of two or more parts. Folded structures are formed between every parts of the support. The support is supported by an elastic component. The structure of the present invention is simple and easy to carry. It overcomes the problems that the floor type projection screen in existing technology need to be manually operated in use or returning time. So it is greatly convenient to use.

### BACKGROUND OF THE INVENTION

1. Field of the Invention

The present invention relates to a projection screen, particularly relates to a floor type electric projection screen cooperatively used with a projector.

2. Description of the Prior Art

With the projection screen is widely used in people's daily life, the family-mode degree of the projection screen is increasing. More and more projection equipments enter in every family. The screen projection in existing technology is initially used for teaching which is generally used of the suspension installation mode. With the downsizing and family-mode of the projection screen, the suspension installation mode more and more can't meet people's demand. Thus the floor type projection screen appears. In the existing floor type projection screen, a scroll is defined in the shell. An end of the projection curtain is wound in the scroll, and the other end of the projection curtain is installed with a cover plate. A spring is installed on the scroll. When it is used, the projection curtain is manually drawn out from the shell. When its demand is reached, the supporting bar is used to support between the shell and the cover plate, then the projection curtain can be supported and can't be automatically returned. When it is finished, the supporting bar is removed and the projection curtain is returned to the shell by the elastic force of the spring installed on the shell. Because the existing projection screen need to be manually drawn out when it is used, and need to be manually returned when it is finished, it is inconvenient to use.

### SUMMARY OF THE INVENTION

An object of the present invention is to overcome the problems that the floor type projection screen need to be manually operated, and inconvenient to use in the existing technology.

To achieve the above object, the present invention provides a floor type electric projection screen comprising a shell, a projection, and a scroll. An end of the projection curtain is wound on the scroll, and the scroll is installed in the shell. A motor is defined in the projection screen. The motor drives the scroll rotating. The other end of the projection curtain is installed on a supporting bar. Supports are installed between the shell and the supporting bar. The support is formed of two or more parts. Folded structures are formed between every parts of the support. The support is supported by an elastic component.

Wherein the motor is the tubular motor. The output shaft of motor is coaxially defined with the scroll, and is fixed together.

The support is formed of two parts, and the two parts are connected by the output shaft.

The support is a hollow pipe, and a spring is installed in the support. An end of the spring is fixed on the supporting bar, and the other end of the spring bypasses the output shaft through a tractive thread and is fixed on the shell.

The supports are symmetrically defined with two groups.

The support bar shows the flat shape, which is matched with the opening shape of the projection curtain passageway on the shell.

A motor driving circuit is installed in the shell.

A control button is installed on the shell, and the control button is connected with the motor driving circuit.

A remote control receiver unit is connected with the motor driving circuit.

The beneficial effects of the present invention: the structure is simple and easy to carry. It overcomes the problems that the floor type projection screen in existing technology need to be manually operated in use or returning time. So it is greatly convenient to use.

### BRIEF DESCRIPTION OF THE DRAWINGS

FIG. 1 is a use state reference diagram of the present invention.

FIG. 2 is a structural schematic diagram of a support provided in the present invention.

FIG. 3 is an internal structural schematic diagram of a support provided in the present invention.

### DESCRIPTION OF THE PREFERRED EMBODIMENT

The technical problem to be solved, the technical solution and the beneficial effects of the present invention are best understood from the following detailed description with reference to the accompanying figures and the embodiment. The preferred embodiment described here is, of course, merely examples to explain the invention and are not intended to limit the present invention.

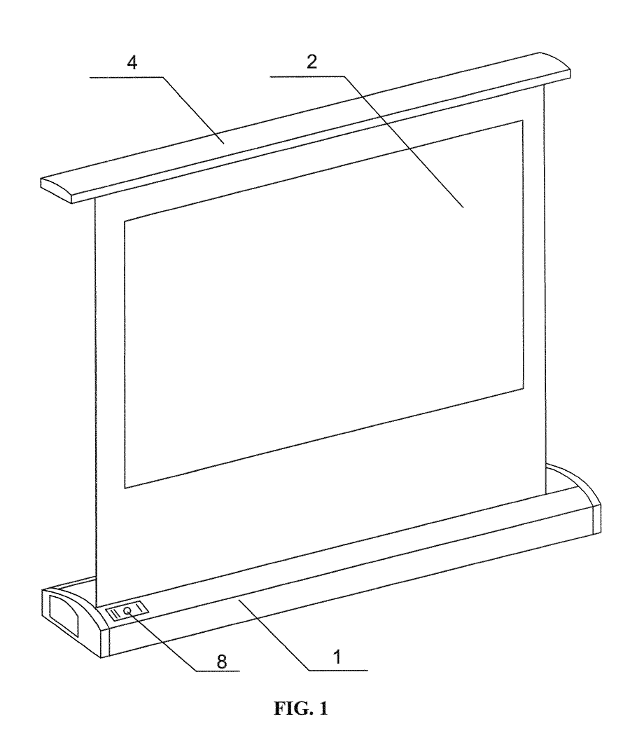

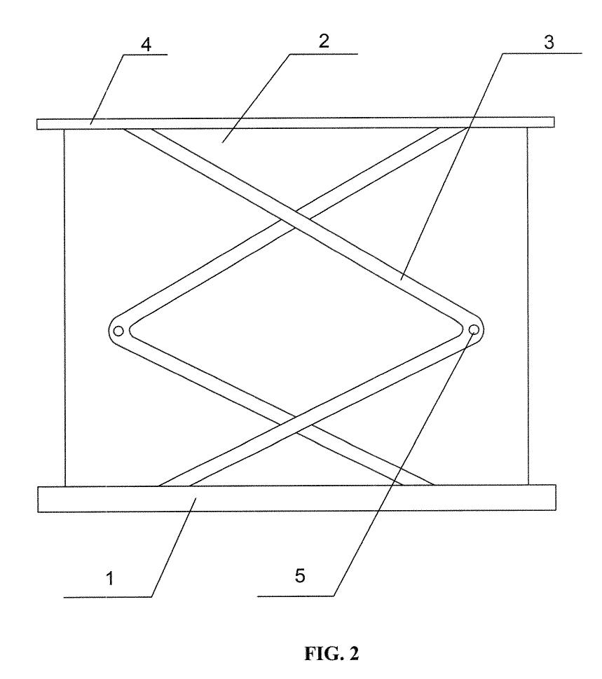

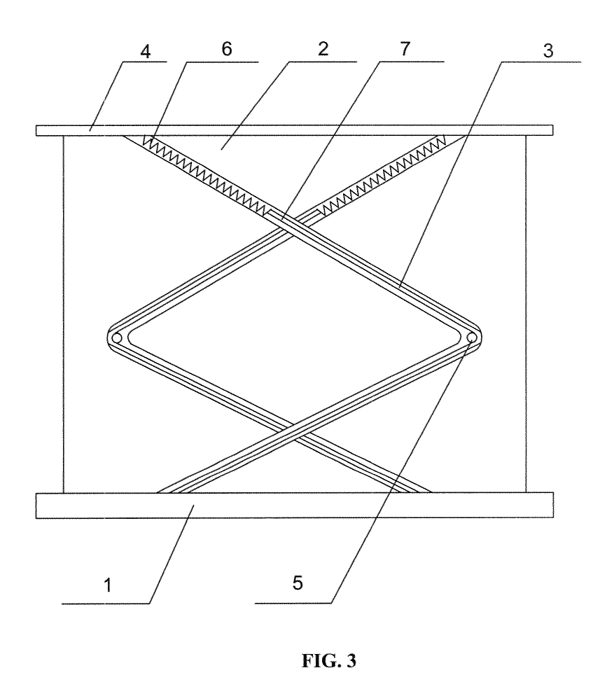

Referring to FIG. 1, FIG. 2 and FIG. 3, the main body of the present invention comprises a shell 1, a projection curtain 2, supports 3, a support bar 4, and a scroll. An end of the projection curtain 2 is fixed on the scroll. When the projection curtain 2 is returned, the projection curtain 2 is wound on the scroll. The scroll is installed in the shell 1. An opening is defined on the shell 1. The projection curtain 2 is stretched out the shell 1 through the opening. The end of the projection curtain 2 in the outside of the shell 1 is fixed with the support bar 4. The support bar 4 shows flat shape, which is matched with the opening shape of the projection curtain passageway on the shell. After the projection curtain 2 is returned, the supporting bar 4 is blocked on the opening of the shell 1, so that the present invention looks beautiful as a whole. When the present invention is used, the projection curtain 2 is supported by the supports 3. Referring specifically to FIG. 2 and FIG. 3, in the embodiment, the support 3 is formed of two parts of mutual connection, and the two parts are connected together by the rotation shaft 5, so that the two parts can be freely rotated along a rotation shaft 5. An end of the support 3 is installed on the support bar 4 through the rotation shaft 5; the other end of the support 3 is installed on the shell through the rotation shaft 5. The support 3 is used of the hollow pipe structure. A spring 6 is installed in the support 3. In the embodiment, an end of the spring 6 is hanged on the supporting bar 4; the other end is hanged on the shell 1 through an attractive thread 7. The tractive thread 7 is wound on the outside of the rotation shaft 5 between the supports 3. When the present invention is opened in use, the projection curtain 2 is opened by the pulling force of the spring 6. That is the spring 6 with the natural state corresponding to the projection screen 2 with the open state. In the embodiment, the supports 3 are used of symmetrical two.

The present invention uses a motor to drive the scroll working. In the embodiment, the motor is tube motor. The output shaft of motor is coaxially defined with the scroll, and is fixed together. The positive or negative rotation of the tubular motor can drive the scroll rotating, so that the projection curtain 2 is opened or returned. In the present invention, a motor driving circuit is installed in the shell, which is used to drive the tubular motor positive rotating or negative rotating. A control button 8 is installed on the shell, and the control button 8 is connected with the corresponding part of the motor driving circuit. The control signals input by the control button 8 control the motor rotating. A remote control receiver unit is also connected with the motor driving circuit, which is used to receive control signals from a remote controller and control the motor rotating.

When the present invention is used, the control signals sent out by the control button 8 or the remote controller control the tubular motor positive rotating. The tubular motor drive the scroll rotating. The spring 6 in the support 3 is stretched and drives the support 3 rotating along the rotation shaft 5 thereof. So that the support is straightened and pushes the support bar 4, then the support bar 4 drives the projection curtain 2 opening. When the use of the present invention is finished, the control signals sent out by the control button 8 or the remote controller control the tubular motor negative rotating. The tubular motor drive the scroll rotating. The projection curtain 2 is wound on the scroll.

The present invention can be widely used in all kinds of teaching or household projection screens in existing technology

While the preferred embodiment of the invention has been defined forth for the purpose of disclosure, modifications of the disclosed embodiment of the invention as well as other embodiment thereof may occur to those skilled in the art. Accordingly, the appended claims are intended to cover all embodiments which do not depart from the spirit and scope of the invention.

What is claimed is:

1. A floor type electric projection screen comprising a shell, a projection, and a scroll, an end of the projection curtain being wound on the scroll, the scroll being installed in the shell, a motor being defined in the projection screen, the motor driving the scroll rotating, the other end of the projection curtain being installed on a supporting bar, supports being installed between the shell and the supporting bar, the support being formed of two or more parts, folded structures being formed between every parts of the support, the support being supported by a elastic component.

2. The floor type electric projection screen of claim 1, wherein the support bar shows the flat shape, which is matched with the opening shape of the projection curtain passageway on the shell.

3. The floor type electric projection screen of claim 1, wherein a motor driving circuit is installed in the shell.

4. The floor type electric projection screen of claim 3, wherein a control button is installed on the shell and the control button is connected with the motor driving circuit.

5. The floor type electric projection screen of claim 3, wherein a remote control receiver unit is connected with the motor driving circuit.

6. The floor type electric projection screen of claim 1, wherein the motor is the tubular motor, the output shaft of motor being coaxially defined with the scroll, and being fixed together.

7. The floor type electric projection screen of claim 6, wherein the support bar shows the flat shape, which is matched with the opening shape of the projection curtain passageway on the shell.

8. The floor type electric projection screen of claim 6, wherein a motor driving circuit is installed in the shell.

9. The floor type electric projection screen of claim 8, wherein a control button is installed on the shell and the control button is connected with the motor driving circuit.

10. The floor type electric projection screen of claim 8, wherein a remote control receiver unit is connected with the motor driving circuit.

11. The floor type electric projection screen of claim 1, wherein the support is formed of two parts and the two parts are connected by the output shaft; or
the support can symmetrically be installed with two groups.

12. The floor type electric projection screen of claim 11, wherein the support bar shows the flat shape, which is matched with the opening shape of the projection curtain passageway on the shell.

13. The floor type electric projection screen of claim 11, wherein a motor driving circuit is installed in the shell.

14. The floor type electric projection screen of claim 13, wherein a control button is installed on the shell and the control button is connected with the motor driving circuit.

15. The floor type electric projection screen of claim 13, wherein a remote control receiver unit is connected with the motor driving circuit.

16. The floor type electric projection screen of claim 11, wherein the support is a hollow pipe, a spring being installed in the support, an end of the spring being fixed on the supporting bar, the other end of the spring bypassing the output shaft through a tractive thread and being fixed on the shell.

17. The floor type electric projection screen of claim 16, wherein the support bar shows the flat shape, which is matched with the opening shape of the projection curtain passageway on the shell.

18. The floor type electric projection screen of claim 16, wherein a motor driving circuit is installed in the shell.

19. The floor type electric projection screen of claim 18, wherein a control button is installed on the shell and the control button is connected with the motor driving circuit.

20. The floor type electric projection screen of claim 18, wherein a remote control receiver unit is connected with the motor driving circuit.
